(19) United States
(12) Patent Application Publication
(10) Pub. No.: US 2014/0259095 A1
(43) Pub. Date: Sep. 11, 2014

(54) METHOD OF PROVIDING CYBER SECURITY AS A SERVICE

(71) Applicant: James Alvin Bryant, Gainesville, VA (US)

(72) Inventor: James Alvin Bryant, Gainesville, VA (US)

(21) Appl. No.: 14/199,875

(22) Filed: Mar. 6, 2014

Related U.S. Application Data
(60) Provisional application No. 61/773,589, filed on Mar. 6, 2013.

(51) Int. Cl. H04L 29/06

(52) U.S. Cl. CPC H04L 63/1433; H04L 63/20
USPC 726/1; 726/25

(57) ABSTRACT

A cyber system including a method of providing cyber security as a service is provided. The cyber system may include an integrated architecture of defensive and offensive security procedures and processes that enable enterprises to practice safe, holistic security techniques. The plurality of cyber defense procedures may include a plurality of risk-based assessment procedures, a plurality of attack-prevention procedures, a plurality of detection procedures and a plurality of response and recovery procedures. The plurality of cyber offense procedures may include a plurality of cyber weapon procedures, a plurality of cyber Intelligence, surveillance and reconnaissance procedures, a plurality of information operations target exploitation procedures and a plurality of information operations attack procedures. The cyber system may also include a plurality of overlapping processes interconnecting the plurality of cyber offense procedures and plurality of cyber defense procedures. The plurality of overlapping processes may include a change management, a configuration management, a service desk and a service-level management. The change management may be structured within an enterprise for ensuring that changes in people, facilities, technology and/or processes are smoothly and successfully implemented to achieve lasting benefits. The configuration management may establish and maintain the consistency of a product's performance, functional and physical attributes with its requirements, design and operational information throughout its life. The service desk may provide the communication needs of the users, employees and customers. Service-level management may assess the impact of change on service quality and establish performance metrics and benchmarks.

### CROSS-REFERENCE TO RELATED APPLICATION

This application claims the benefit of priority of U.S. provisional application No. 61/773,589 filed 6 Mar. 2013 the contents of which are herein incorporated by reference.

### BACKGROUND OF THE INVENTION

The present invention relates to cyber security and, more particularly, to a process and procedure framework for providing cyber security as a service.

Current cyber security procedures and or processes are fractured and disparate while not providing holistic protection over an enterprise's entire information and data profile. As a result, enterprises lack the defensive and offensive capabilities to preclude, minimize and or offensively respond to cyber attacks on their information systems.

As can be seen, there is a need for an improvement method of performing cyber security as service that consolidate cyber offensive and defensive procedures into a cohesive framework.

### SUMMARY OF THE INVENTION

In one aspect of the present invention, a method of providing a cyber security defense comprises: assessing a plurality of security risks in an information technology infrastructure; implementing a plurality of attack-prevention procedures configured to control access to the information technology infrastructure; providing a plurality of security policies for the information technology infrastructure; employing a plurality of cyber defense procedures configured to detect at least one violation of the plurality of security policies; and implementing a plurality of response and recovery procedures configured to automatically respond to the at least one violation of the plurality of security policies.

In another aspect of the present invention, a method of providing a cyber security offense comprises: implementing a plurality of cyber weapon procedures configured to attack a plurality of targeted networks and information systems; implementing a plurality of cyber intelligence surveillance and reconnaissance procedures configured to assess the weaknesses of the plurality of targeted networks and information systems; implementing a plurality of information operation target exploitation procedures configured to collect, destroy and disrupt data contained within the plurality of targeted networks and information systems; and implementing a plurality of information operation attack procedures configured to circumvent the security controls of the plurality of targeted networks and information systems, wherein the access is used to destroy resources and data controls of the plurality of targeted networks and information systems.

In another aspect of the present invention, a method of providing a cyber security defense and offense comprises: assessing a plurality of security risks in an information technology infrastructure; implementing a plurality of attack-prevention procedures configured to control access to the information technology infrastructure; providing a plurality of security policies for the information technology infrastructure; employing a plurality of cyber defense procedures configured to detect at least one violation of the plurality of security policies; implementing a plurality of response and recovery procedures configured to automatically respond to the at least one violation of the plurality of security policies; implementing a plurality of cyber weapon procedures configured to attack a plurality of targeted networks and information systems; implementing a plurality of cyber intelligence surveillance and reconnaissance procedures configured to assess the weaknesses of the plurality of targeted networks and information systems; implementing a plurality of information operation target exploitation procedures configured to collect, destroy and disrupt data contained within the plurality of targeted networks and information systems; and implementing a plurality of information operation attack procedures configured to circumvent the security controls of the plurality of targeted networks and information systems, wherein the access is used to destroy resources and data controls of the plurality of targeted networks and information systems.

These and other features, aspects and advantages of the present invention will become better understood with reference to the following drawings, description and claims.

### BRIEF DESCRIPTION OF THE DRAWINGS

FIG. 1 is a flowchart of an exemplary embodiment of the present invention;

FIG. 2 is a continuation of the flowchart from FIG. 1 of an exemplary embodiment of the present invention; and

FIG. 3 is a continuation of the flowchart from FIG. 1 and FIG. 2 of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cyber system including a method of providing cyber security as a service. The cyber system may include an integrated architecture of defensive and offensive security procedures and processes that enable enterprises to practice safe, holistic security techniques. The plurality of cyber defense procedures may include a plurality of risk-based assessment procedures, a plurality of attack-prevention procedures, a plurality of detection procedures and a plurality of response and recovery procedures. The plurality of cyber offense procedures may include a plurality of cyber weapon procedures, a plurality of cyber Intelligence, surveillance and reconnaissance procedures, a plurality of information operations target exploitation procedures and a plurality of information operations attack procedures.

The cyber system may also include a plurality of overlapping processes interconnecting the plurality of cyber offense procedures and plurality of cyber defense procedures. The plurality of overlapping processes may include a change management, a configuration management, a service desk and a service-level management. The change management may be structured within an enterprise for ensuring that changes in people, facilities, technology and/or processes are smoothly and successfully implemented to achieve lasting benefits. The configuration management may establish and maintain the consistency of a product's performance, functional and physical attributes with its requirements, design and operational information throughout its life. The service desk may provide the communication needs of the users, employees and customers. Service-level management may assess the impact of change on service quality and establish performance metrics and benchmarks.

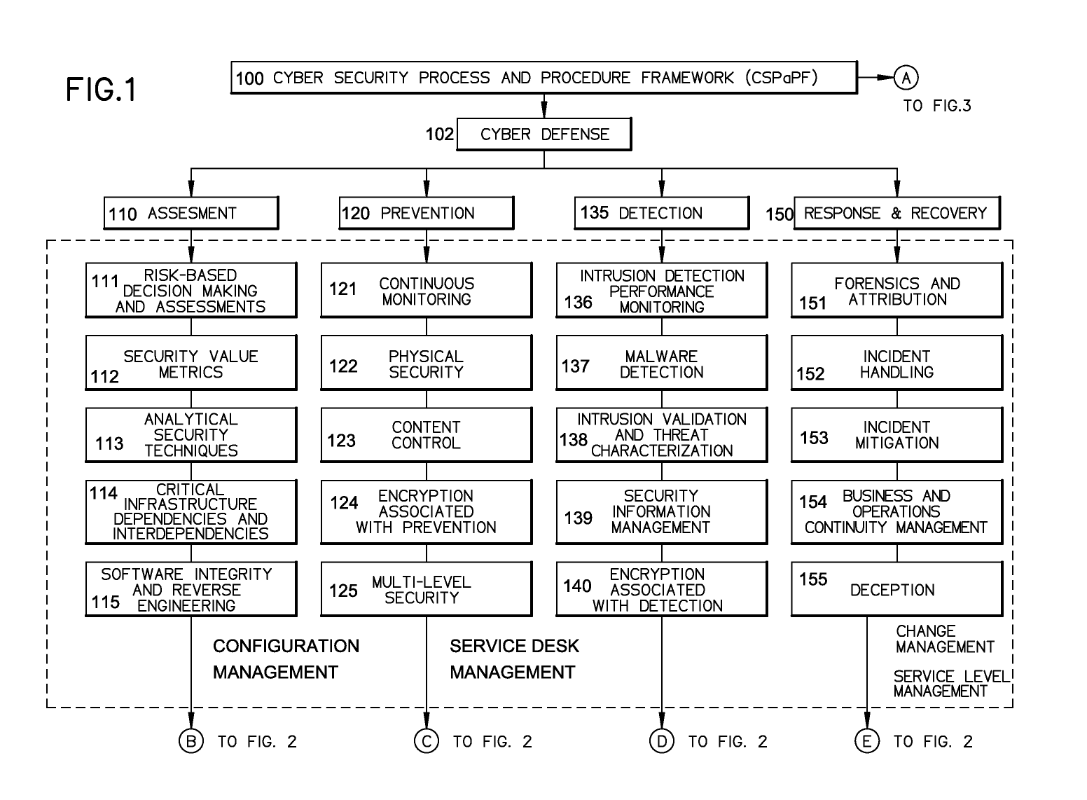

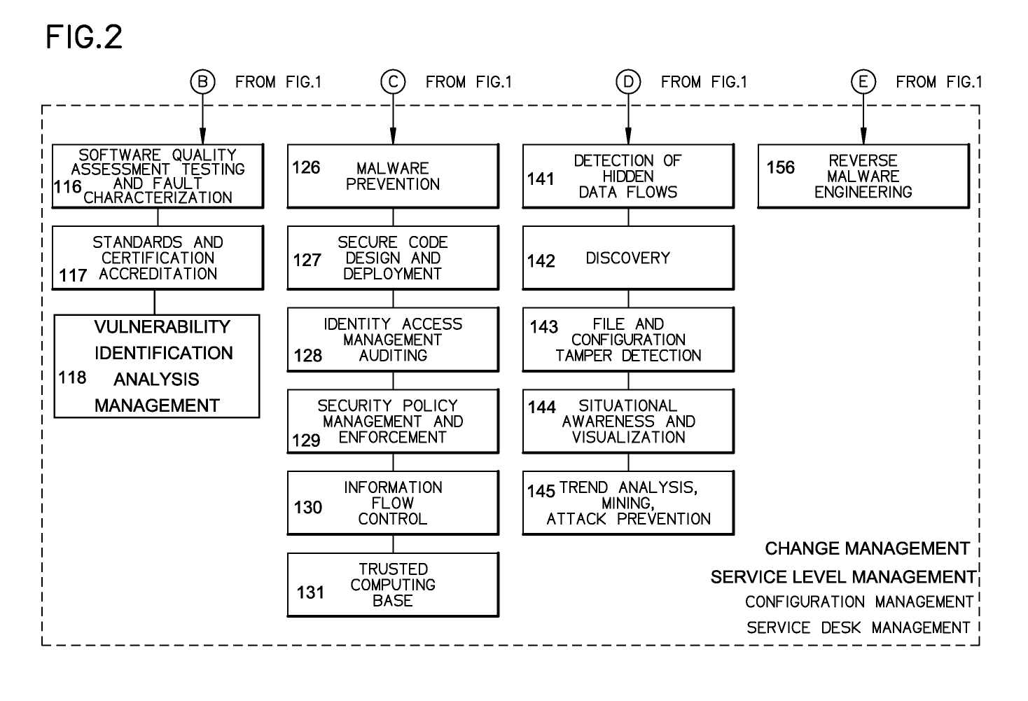

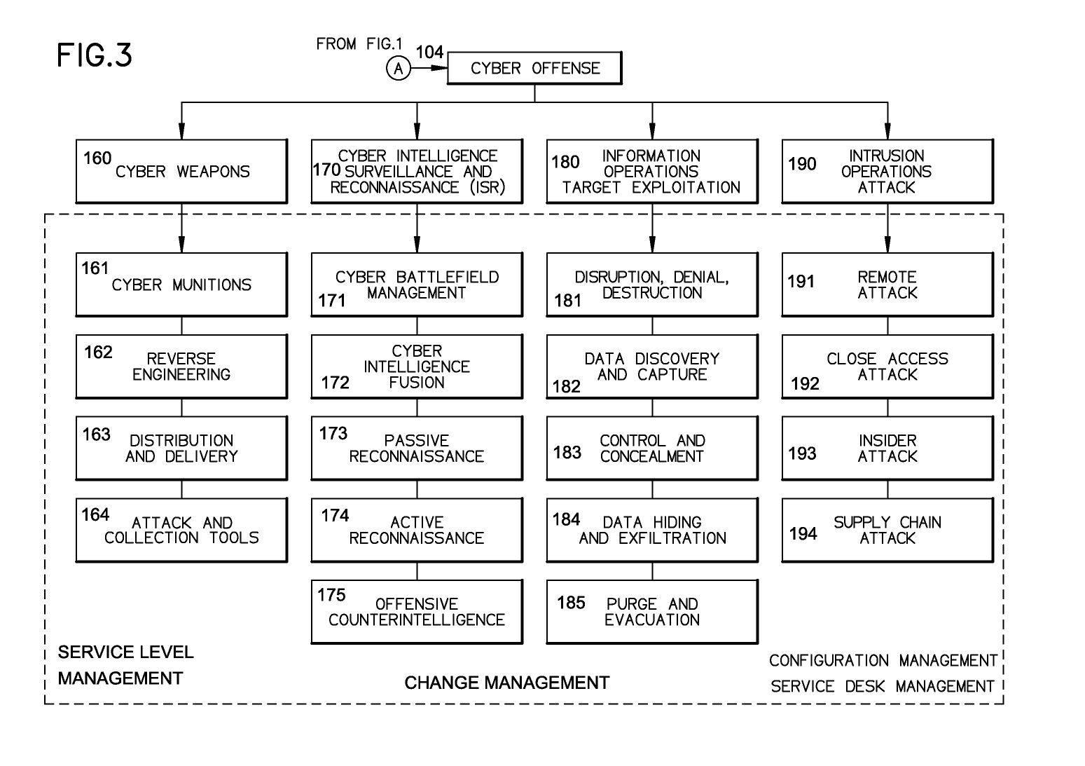

Referring to FIGS. 1 through 3, the present invention may include a cyber system 100. The cyber system 100 may include at least one computer with a user interface. The computer may include at least one processing element, such as a central processing unit (CPU), and some form of memory. The computer may include, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like. The at least one computer may be coupled to a network. The network may, for example, be the Internet, a local area network for a specific site of an enterprise, or may span geographically distributed sites within the enterprise. In other words, network may include one or more Local Area Networks (LANs), Wide Area Network (WANs), Wireless LANs or the like.

The cyber system 100 may include a plurality of Cyber Defense Procedures 102 and a plurality of Cyber Offense Procedures 104.

The cyber system 100 may be an integrated architecture of security standards including the plurality of Cyber Defense Procedures 102 that enable enterprises to practice safe security techniques to minimize the number of successful cyber security attacks by providing the following process. The plurality of Cyber Defense Procedures 102 may include a plurality of risk-based assessment procedures 110, a plurality of attack-prevention procedures 120, a plurality of detection procedures 135 and a plurality of Response and Recovery procedures 150.

First, the plurality of Cyber Defense Procedures 102 may implement a plurality of risk-based assessment procedures 110 for evaluating testing and/or measuring security and risk in IT infrastructure components and systems and in the infrastructure as a whole.

The plurality of risk-based assessment procedures 110 may include a Risk-Based Decision Making and Assessments step 111 including making decisions based on an accurate assessment of such risk to the information being protected; combining the concepts of assessing the threat to the information, the vulnerabilities in the system (Physical and Logical) protecting the information, and the value of the information being protected; employing appropriate mitigation and protection mechanisms so as to offset such risk, including reducing the vulnerabilities, adding new protection mechanisms, a and other such measures.

The plurality of risk-based assessment procedures 110 may include a Security Value Metrics step 112 including defining, measuring and assessing the performance of security measures that may used to protect information, including technical measurements, such as intrusions prevented to nontechnical measures, number of personnel completing security awareness, training, defining appropriate security metrics to the enterprise and the like.

The plurality of risk-based assessment procedures 110 may include a Analytical Techniques for Security Across the IT Systems Engineering Life Cycle step 113 including analytical techniques for security that focuses on testing and evaluating an information system throughout all phases of its development, operation and retirement. The Analytical Techniques for Security Across the IT Systems Engineering Life Cycle step 113 may include requirements review and evaluation, architecture review and analysis, structured code reviews, functional security testing and other such activities. The Analytical Techniques for Security Across the IT Systems Engineering Life Cycle step 113 may include the use of tests of design and tests of operating effectiveness on the controls structure put in place to security the system and protect its data.

The plurality of risk-based assessment procedures 110 may include a Critical Infrastructure Dependencies and Interdependencies step 114 including evaluating the impact of interconnected systems. The Critical Infrastructure Dependencies and Interdependencies step 114 may include evaluations of critical connections between infrastructures, system architecture analysis, vulnerability analysis and impact analysis. The outputs of such a capability are causal analyses, joint risk analyses, and other such informational reporting, which may then be used to determine the effects of various types of actions taken against at least one of the interconnected infrastructures.

The plurality of risk-based assessment procedures 110 may include a Software Integrity and Reverse Engineering step 115 including capabilities that ensure the secure operation of software. Software integrity refers to those measures taken to ensure that code may not changed from its known good state including the use of hashing and other integrity-checking algorithms and may be designed to defeat attacks that focus on adding malicious code to known applications. Reverse engineering may include the process by which software binaries and executables are disassembled and reviewed to determine the actions taken by the application. The Software Integrity and Reverse Engineering step 115 may employ when the original source code to an application may be unavailable for inspection by a competent software reviewer.

The plurality of risk-based assessment procedures 110 may include a Software Quality Assessment, Testing and Fault Characterization step 116 including software assessment and testing. The Software Quality Assessment, Testing and Fault Characterization step 116 may include evaluating the software functions' reliability and limiting its functions to which it was designed, conducting thorough evaluations of the software throughout its lifecycle from requirements, development and through application retirement, such as but not limited to application source code review, load testing, functional testing, use case testing, abuse case testing, and uncovering, understanding, classifying, fixing software faults/vulnerabilities characterization includes faults of all types and may not be limited other security vulnerabilities.

The plurality of risk-based assessment procedures 110 may include a Standards and Certification Accreditation step 117 including capability to respond to and comply with the appropriate governance authorities that have jurisdiction over the information and its supporting systems in an enterprise. The Standards and Certification Accreditation step 117 may include evaluation in one or more of the following areas: legal compliance, which may be focused on ensuring that the enterprise's information systems and processes comply with applicable local, state, federal and international law; regulatory compliance which may be focused on ensuring that the systems and processes comply with regulatory practices specific to the industry or industries in which the enterprise operates (e.g., SOX404, Etc.); and system certification and accreditation which may be focused on ensuring the deployed information systems are appropriately designed, tested and implemented to provide a predetermined level of protection to the information, and that they may be granted the authority to operate.

The plurality of risk-based assessment procedures 110 may include a Vulnerability Identification, Analysis and Management step 118 including vulnerability identification, analysis and management so as to identify, quantify, and prioritize the vulnerabilities in a system. The Vulnerability Identification, Analysis and Management step 118 may include systems for which vulnerability assessments are performed include, such as but are not limited to, information technology systems, energy supply systems, water supply systems, transportation systems, and communication systems.

Second, the plurality of Cyber Defense Procedures 102 may implement the plurality of attack-prevention procedures 120 targeted at the prevention of well know cyber security attacks and control of access to resource by valid consumers.

The plurality of attack-prevention procedures 120 may include Continuous Monitoring step 121 so as to detect compliance and risk issues associated with an enterprise's cyber security and operational environments. Continuous monitoring systems may include examining 100% of transactions and data processed in different applications and databases. The Continuous Monitoring step 121 may test for inconsistencies, duplication, errors, policy violations, missing approvals, incomplete data, dollar or volume limit errors, or other possible breakdowns in internal controls.

The plurality of attack-prevention procedures 120 may include a Physical Security step 122 including mechanisms and techniques that protect the physical aspects of an enterprise from disclosure, intrusion, and attack. With regards to cyber security, physical security may include, but is not limited to, secure network wiring, RF shielding, backup power sources, and network security devices at the physical network layer. The Physical Security step 12 may include measures to protect machines from use of prohibited devices (e.g., USB devices) by techniques that disable, remove, and deny physical access.

The plurality of attack-prevention procedures 120 may include a Content Control step 123 including technologies that support confidentiality, integrity, availability, sanitization, and use control objectives to interdict “unacceptable” content while protecting “good” enterprise-owned content-such as business documents and digital media-wherever they may be.

The plurality of attack-prevention procedures 120 may include a Encryption Associated with Prevention step 124 including technologies and techniques used to limit the disclosure of information to only authorized individuals, entities, or processes through the generation of cipher text from corresponding clear text by application of a cryptographic algorithm and a deny to prevent anyone but the intended recipient from reading the data.

The plurality of attack-prevention procedures 120 may include a Multi-Level Security step 125 including an application of cyber security on systems containing information with different sensitivities (e.g. different security levels) that simultaneously permit access by users with different security clearances and need-to-know, but that prevents users from obtaining access to information for which they lack the necessary clearances and/or need-to-know. The Multi-Level Security step 125 may allow access to less-sensitive information by higher-cleared individuals and it may allow higher and or cleared individuals to share sanitized documents with less-cleared individuals. A sanitized document may be one that has been edited to remove information that the less-cleared individuals in to allowed to see.

The plurality of attack-prevention procedures 120 may include a Malware Prevention step 126 including mechanisms and techniques that prevent the delivery, detect the existence, and provide remedies to remove malicious software, including techniques and procedures that limit or control, via configuration settings, the mechanisms and mean used by malware to exploit vulnerabilities in a particular execution environment (e.g., disable auto run). The Malware Prevention step 126 may include eradication or potential quarantine of viruses, Trojans, rootkits, spyware, and other malicious code from a system. Quarantine typically occurs when a file infected with malicious code or virus cannot be removed; instead it may be relocated to an area where it cannot do any harm.

The plurality of attack-prevention procedures 120 may include a Secure Code Design and Deployment 127. Languages used throughout software development, from low-level assembly languages and machine code, to conventional programming languages used for application development, to high-level modeling and specification. Security requirements may be also expressed in languages. Security-centric programming languages address security as part of the language and incorporate features (or the absence of features) to increase the assuredness of code written in the language. Software engineering may be the application of engineering methods, technologies, tools, and practices to the systematic development of computer software. Security may be a component of software engineering, and security requirements must be met just as the requirements for functional correctness must be. The primary goal of secure software engineering may be the design, development, verification, and validation of secure and correct software.

The plurality of attack-prevention procedures 120 may include an Identity Management, Access Management, Auditing 128 including various security services required for the management of information associated with an entity (e.g., users, devices, services) that may be used with various mechanisms to establish verifiable proof of any entity's identity to an outline system an control access to resources (e.g., network, machine, application, service) based on an evaluation of the criteria defined in a security policy which may be expressed in a number of different models (e.g., privileges, rights, roles, attributes, identity). Identity management may deal with the entire lifecycle of the information including the established, provisions, de-provisioning, and destruction of the identity and trust relationships between security domains. Auditing may be the recording of security decisions, along with the material that was used in making the decision, in a secure and consistent manner. The audit records typically may be recorded in such a fashion so the detection of tampering (e.g., changing, deleting, inserting of false records) may be detected.

The plurality of attack-prevention procedures 120 may include a Security, Policy Management and Enforcement 129 including the management and enforcement of security policies by both electronic and human means to ensure a level of compliance. Security policy enforcement must include processes and procedures of the assessment and measurement of policy compliance using quantitative techniques that may be repeatedly performed, often by a human, and produce results may be recorded so as to be proof of compliance. In cases where human enforcement may be required, the processes and procedures for the assessment and measurement of policy compliance must be written down so that they may be provided to for independent verification, if necessary.

The plurality of attack-prevention procedures 120 may include an Information Flow Control step 130 including a procedure to ensure that information transfers within a system may be not made from a higher security level entity to an entity of lower security level. A subject at a given security level cannot read data that resides at a higher security level, nor may it write information to a lower security level. The principles involved in information flow control may apply not only to information at security levels, but also to information flows, not just the direction of the flow. The information flow may also be affected by service level agreements, traffic patterns, and performance of network components, machine, application and services.

The plurality of attack-prevention procedures 120 may include a Trusted Computing Base (TCB) 131 including the plurality of all system hardware, firmware and software that may be relied upon to enforce the system's security policy. The ability of a TCB to correctly enforce a security policy may depend on the mechanisms with the TCB and on the correct input by system administrative personnel of parameters related to the security policy.

Third, the plurality of Cyber Defense Procedures 102 may implement a plurality of detection procedures 135 to detect activity outside the normal bounds of acceptable behavior and activity violating or potentially violating the defined security policy.

The plurality of detection procedures 135 may include an Intrusion Detection Step 136a including the capability to assimilate information from network devices, machines, infrastructure, applications/services, and other sources of information and utilize the information as input tan attack/pre-attack pattern sensing function which may evaluate whether the information indicates whether a potential intrusion may have been being attempted. The Intrusion Detection Step 136a may provide outputs indications of possible attack to the warning systems, and receives attack evaluation information from the threat data management system.

The plurality of detection procedures 135 may include a Performance Monitoring step 136b including the capability to assimilate information from network devices, machines, infrastructure, applications/services, and other sources of activity information an environment and utilizes the information as input to an attack/pre attack patter sensing function which may evaluate whether the information indicates whether a potential intrusion may have been being attempted. The Performance Monitoring step 136b may provide outputs indications of possible attack to the warning systems, and receives attack evaluation information from the threat data management system.

The plurality of detection procedures 135 may include a Malware Detection step 137 including the capability to sense viruses, trojans, root kits, and other forms of malicious code by assimilating information from network, devices, machines, operating systems, infrastructure, applications/services, and other sources of information in an environment. The Malware Detection step 137 may provide outputs indications of possible viruses or malicious software to the warning system. The Malware Detection step 137 may receive virus updates from the threat data system.

The plurality of detection procedures 135 may include a Intrusion Validation and Threat Characterization step 138 including the capability to warn of valid intrusion events through the evaluation of real-time alerts and events which may distinguish valid patterns of intrusion from acceptable system activity. The Intrusion Validation and Threat Characterization step 138 may provide information about verified security breaches to the threat characterization and response activities

The plurality of detection procedures 135 may include a Security Information Management step 139 including the capability to collect, stage, aggregate, and cleanse intrusion data from network protection devices (firewalls, VPNs, routers, etc.), machines, infrastructure components, application/service hosting containers, applications/service, and sensor (NIDS<HIDSs, policy compliance checkers, vulnerability scanners, etc.) included in the environment. The Security Information Management step 139 may include capabilities responsible for the integrity of the infrastructure, the capability for correlation and reduction provides an intelligent mechanism to integrate data collect across multiple sensors and the like. The Security Information Management step 139 may include data aging by rolling or aging data out of the online data warehouse.

The plurality of detection procedures 135 may include a Encryption Associated with Detection step 140 including the capability for transforming readily readable information into a data stream that may be unreadable to anyone by the intended recipients. The Encryption Associated with Detection step 140 may include such concepts as cipher text plaintext, symmetric and asymmetric keys, public and provide key cryptography, and decryption which is the opposite of encryption. Encryption may be used to identify the sender of information (authentication or identification) to guarantee the content of information flow has not changed (integrity), and to hide the content information flow (confidentially).

The plurality of detection procedures 135 may include a Detection of Hidden Data Flows step 141 including the art and science of hiding information within messages in such a way that no one apart from the intended recipient knows of the existence of the hidden information. For example, information and C2 may be incorporated in normal network traffic like DNS or HTTP communications. In addition, binary payload such as an image, sound, or music in such a manner to make the detection of its existence difficult. The Detection of Hidden Data Flows step 141 may include detecting information hidden within a stream of information that is transmitted form one entity to another.

The plurality of detection procedures 135 may include a Discovery step 142 including the capability to identify and gather information about network devices, machines, infrastructure components, application/service hosting containers, and applications/services that may not authorized to be part of an environment. The Discovery step 142 may include providing information regarding unauthorized entities to the warning entity, such as but not limited to finger printing, foot printing, crawling and war dialing and driving.

The plurality of detection procedures 135 may include a File and Configuration Tamper Detection step 143 including the capability to sense malicious modifications and corruption of file sand configuration information by assimilating information from network devices, machines, operating systems, infrastructure, applications/services, and other sources of information in an environment an comparing it to a baseline. The File and Configuration Tamper Detection step 143 may include proactive configuration assessment so as to reveal where settings don't align with internal policies, best practices and compliance requirements so enterprises may get configurations into a desired state. The File and Configuration Tamper Detection step 143 may include proven change detection alerts it to any configuration changes that jeopardize this desired state or introduce risk.

The plurality of detection procedures 135 may include a Situational Awareness and Visualization step 144 including the capability to warn operational and security individuals of the security posture of a specified environment through a graphical visualization to provide for an indication of situational awareness. Situational awareness may be an integral part of an information assurance common operational picture. Situational Awareness and Visualization step 144 may provide a graphical, statistical, and analytical view of thereat information, performance data, and anomalies.

The plurality of detection procedures 135 may include a Situational Trend Analysis, Mining, Attack Prediction step 145 including the capability to warn operational and security individuals of trends in security attacks and the tools to discern non-obvious information and establish a broad view from a large amount of data. The trending capabilities may include support for automated knowledge discovery (manual and automated tools to detect and characterize actionable patterns in data). The ad-hoc query and data mining capabilities may provide at least two levels of structured interfaces to the data: a simple “point and click” interface for creating and requesting canned reports by novice user (non-programmers), and a structured environment that makes it easy to access the data with a variety of more sophisticated analysis tools for more advanced users. The Situational Trend Analysis, Mining, Attack Prediction step 145 may include attack prediction capabilities providing the individual with the tools needed to forecast attacks based on events that have been occurring.

Fourth, the plurality of Cyber Defense Procedures 102 may implement a plurality of Response and Recovery procedures 150 so as to provide automatic protective actions in the face of an attack and capabilities for analyzing an assessing damage as a result of an attack. The capabilities for response may be intended to prevent pending attacks and mitigate the effects of an attack in-progress in order to minimize damage or restore normal system and network operations. The capabilities for investigation may be intended to provide tools and services for analyzing attacks, assessing attack damage, and gathering forensic evidence.

The plurality of Response and Recovery procedures 150 may include a Forensics and Attribution step 151 including the capability focused on the investigative questions as to what may have been attacked, what may be the extent of the damage, where did the attack originate; how did it propagate and who (e.g. person, enterprise, country) or what may have been responsible. The Forensics and Attribution step 151 may utilize cyber forensics to collect evidence, trace back to determine origin, and attribution to assess responsibility into the process of investigating cyber anomalies, violations, and attacks.

The plurality of Response and Recovery procedures 150 may include an Incident Handling step 152 including the capability to provide guidance for appropriately handling an incident based on a set of published procedures. The Incident Handling step 152 may utilize incident response history data from the threat data management entity and provides incident handling guidance to security analysis. The Incident Handling step 152 may include, but is not limited to, instructions for dissemination of attack details via format and ad-hoc channels, Points of Contact, and response procedures. This function may be fully automated or rely on “help desk” services.

The plurality of Response and Recovery procedures 150 may include an Incident Mitigation step 153 including the capability to initiate an appropriate response in a proactive manner, based on policy, to effect a temporary change in configuration or policy as a means to defend against an active attack. Based on the security policy in effect and the nature of the attack, the temporary changes could result in the disablement of a session, account, or service, termination or blocking of connections from particular origins, tightening of access and authorization policies, or the transparent redirection to a deception technique to allow for monitoring of the attack. The stimulus to initiate this capability typical comes from a Warning capability, while the enforcement may be provided by a Protection capability. The association of the necessary protection actions and configuration changes for a given set of warnings may be the responsibility of his capability.

The plurality of Response and Recovery procedures 150 may include an IT Service Continuity Management step 154 including capability focused on the methods, best practices and services for returning business rhythms to an operational state (quickly, safely, efficiently).

The plurality of Response and Recovery procedures 150 may include a Deception step 155 including the capability to utilize deception to drive hackers/attackers away from production systems into an environment where their activities may be contained and monitored. The Deception step 155 may involve the use of devices (e.g., honeypots, Honeynets) and/or be constituted as a dynamic update in routing policy or address resolution.

The plurality of Response and Recovery procedures 150 may include a Reverse Malware Engineering step 156 including reverse code engineering of malicious code so as to unpack, decompile, and decompose the code to assembly-level machine instructions for analysis and understanding of the binary code's interaction with a target operating system's CPU registers, such as by using interactive dissemblers and debuggers that trace, register and recognize procedures, API calls, switches, tables, constants and strings, and locate routines from object file an libraries. The Reverse Malware Engineering step 156 may include analyzing benign and malicious code that may have been packed prior to installation as well as malicious code that may also obfuscate and often includes anti-forensic mechanisms to hamper disassembly and analysis.

The cyber system 100 may also be an integrated architecture of security standards including the plurality of Cyber Offense Procedures 104 that include capabilities used to gain access to, collect information from, or to disrupt, deny or destroy targeted networks and information systems. The plurality of Cyber Offense Procedures 104 may include a plurality of cyber weapon procedures 160, a plurality of Cyber Intelligence, Surveillance and Reconnaissance (ISR) procedures 170, a plurality of Information Operations Target Exploitation procedures 180 and a plurality of Information Operations Attack procedures 190.

First, the plurality of Cyber Offense Procedures 104 may implement the plurality of cyber weapon procedures 160 that may include capabilities used to gain access to, collect information from, or to disrupt, deny or destroy targeted networks and information systems.

The plurality of cyber weapon procedures 160 may include a Cyber Munitions step 161 including capabilities using Software or hardware devices to deny disrupt or destroy targeted network or information systems resources or data.

The plurality of cyber weapon procedures 160 may a Reverse Engineering step 162 including offensive reverse code engineering (RCE) capabilities used to conceal and protect malicious code used in attack and collection tools and cyber munitions.

The plurality of cyber weapon procedures 160 may a Distribution and Delivery step 163 including logical or physical operational capabilities for delivery of attack and collection tools or cyber munitions to intended target.

The plurality of cyber weapon procedures 160 may a Attack and Collection Tools step 164 including capabilities using SW and HW tools and devices to assess attack, gain access to or to exploit targeted networks, information systems or data.

Second, the plurality of Cyber Offense Procedures 104 may implement the plurality of Cyber Intelligence, Surveillance and Reconnaissance (ISR) procedures 170 that may include collection and analysis capabilities used to create and sustain offensive and defensive global cyber situational awareness

The plurality of Cyber (ISR) procedures 170 may include a Cyber Battlefield Management step 171 including capabilities providing situational awareness of global cyber offensive capabilities, activities, defenses, and support to management of offensive information operations.

The plurality of Cyber (ISR) procedures 170 may include a Cyber Intelligence Fusion step 172 including capabilities using intelligence collection, analysis to provide global cyber offensive and defensive situational awareness.

The plurality of Cyber (ISR) procedures 170 may include a Passive Reconnaissance step 173 including capabilities using remote monitoring and external analysis of target IP traffic and its system and network resources to assess its external attack surface.

The plurality of Cyber (ISR) procedures 170 may include an Active Reconnaissance step 174 including capabilities using active probing and analysis of target IP traffic and system and network resources to assess its internal attack surface.

The plurality of Cyber (ISR) procedures 170 may include an Offensive Counterintelligence step 175 including capabilities used to deceive hostile offensive and defensive cyber operations in order to misdirect opposing resources and capabilities.

Third, the plurality of Cyber Offense Procedures 104 may implement the plurality of Information Operations Target Exploitation procedures 180 that may include capabilities using information system or network resources to capture and exfiltrate data, modify data or to disrupt, deny or destroy network and information system resources or data.

The plurality of Information Operations Target Exploitation procedures 180 may include a Disruption, Denial, Destruction step 181 including capabilities using any attack method to disrupt, deny or destroy target network and information system resources, data or communications.

The plurality of Information Operations Target Exploitation procedures 180 may include a Data Discovery and Capture step 182 including capabilities used to explore directories, file shares, databases and repositories in the target environment to discover and capture data of interest.

The plurality of Information Operations Target Exploitation procedures 180 may include a Control and Concealment step 183 including capabilities used to establish administrative control, suborn or disable network and information system security controls, gain and sustain access to targeted data and resources, and hide malicious activity in the target environment.

The plurality of Information Operations Target Exploitation procedures 180 may include a Data Hiding and Exfiltration steps 184 including capabilities used for hiding and clandestine export of captured data to remote destinations for analysis.

The plurality of Information Operations Target Exploitation procedures 180 may include a Purge and Evacuation step 185 including capabilities used to remove or hide inserted SW and HW and restore network and information system resources to pre-attack configuration and security baselines after exploitation may be complete.

Fourth, the plurality of Cyber Offense Procedures 104 may implement the plurality of Information Operations Attack procedures 190 that may include capabilities using the internet, or networks and information systems to gain access to or to disrupt, deny or destroy targeted network and information systems resources and data.

The plurality of Information Operations Attack procedures 190 may include a Remote Attack step 191 including capabilities using remote access methods to circumvent network and information system perimeter and internal security controls to gain access to target resources and data, mount a denial of service (DOS).

The plurality of Information Operations Attack procedures 190 may include a Close Access Attack step 192 including capabilities using close proximity or physical access to circumvent network and information system security controls to gain access to target resources and data, mount a DDS attack or to destroy information systems or data.

The plurality of Information Operations Attack procedures 190 may include a Insider Attack step 193 including capabilities used by an authorized user to actively circumvent system and network internal technical administrative, and operational security controls to gain access to targeted information systems and data.

The plurality of Information Operations Attack procedures 190 may include a Supply Chain Attack step 194 including capabilities for insertion of malicious HW or SW into COTS products during design, production or delivery or disruption of critical resource provisioning.

A method of using the present invention may include the following. The cyber system 100 disclosed above may be provided. The cyber system 100 may also include a plurality of overlapping processes interconnecting the plurality of cyber offense procedures and plurality of cyber defense procedures facilitate use by users and or the customers. The plurality of overlapping processes may include a change management, a configuration management, a service desk and a service-level management. “User” may refer to the actual user of the services, while “Customer” may refer to the entity that may be paying for the services. The plurality of overlapping processes may include a Change Management, a Configuration Management, a Service Desk and a Service-level Management

The Change Management may be structured within an enterprise for ensuring that changes in people, facilities, technology and/or processes are smoothly and successfully implemented to achieve lasting benefits.

The Configuration Management may provide systems engineering process for establishing and maintaining consistency of a product's performance, functional and physical attributes with its requirements, design and operational information throughout its life.

The Service Desk may provide a Single Point of Contact to meet the communication needs of both Users and IT employees as well as to satisfy both Customer and IT Provider objectives. The Service Desk may primary be IT service for IT service management (ITSM) as defined by the Information Technology Infrastructure Library (ITIL).

The Service-level Management may provide for continual identification, monitoring and review of the levels of IT services specified in the Service-level agreements (SLAB). Service-level management may provide arrangements with internal IT support-providers and external suppliers in the form of Operational Level Agreements (OLAs) and Underpinning Contracts (UCs), respectively, such as but not limited to, assessing the impact of change on service quality and SLAB. The service-level management process may be in close relation with the operational processes to control their activities. The central role of Service-level management may make it the natural place for metrics to be established and monitored against a benchmark.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that may be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of providing a cyber security defense comprising:
assessing a plurality of security risks in an information technology infrastructure;
implementing a plurality of attack-prevention procedures configured to control access to the information technology infrastructure;
providing a plurality of security policies for the information technology infrastructure;
employing a plurality of cyber defense procedures configured to detect at least one violation of the plurality of security policies; and
implementing a plurality of response and recovery procedures configured to automatically respond to the at least one violation of the plurality of security policies.

2. The method of claim 1, wherein assessing the plurality of security risks comprises the steps of:
assessing a level of threat of an attack of the information technology infrastructure;
assessing a vulnerability level within the information technology infrastructure; and
assigning a value to the information within the information technology infrastructure.

3. The method of claim 1, wherein assessing the plurality of security risks comprises the step of:
defining, measuring, and assessing a performance level of security measures used to protect the information technology infrastructure.

4. The method of claim 1, wherein assessing the plurality of security risks comprises the step of:
testing and evaluating the information technology infrastructure throughout phases of development, operation and retirement.

5. The method of claim 1, wherein assessing the plurality of security risks comprises the step of:
evaluating a plurality of impacts of a plurality of interconnected systems comprising evaluations of connections between infrastructures.

6. The method of claim 1, wherein assessing the plurality of security risks comprises the step of:
preventing unauthorized changes in a software code of the information technology infrastructure.

7. The method of claim 6, wherein assessing the plurality of security risks comprises the step of:
assessing the reliability of the software code and limiting the functions of the software code to the software code's intended function.

8. The method of claim 1, wherein implementing the plurality of attack-prevention procedures comprises the step of:
monitoring of a plurality of transactions and data processed within the information technology infrastructure.

9. The method of claim 1, wherein implementing the plurality of attack-prevention procedures comprises the step of:
implementing a plurality of mechanisms and techniques to protect a plurality of physical technologies within the information technology infrastructure.

10. The method of claim 1, wherein implementing the plurality of attack-prevention procedures comprises the step of:
implementing a content control mechanism comprising a filter for preventing a plurality of preset content from entering the information technology infrastructure.

11. The method of claim 1, wherein implementing the plurality of attack-prevention procedures comprises the step of:
encrypting information to be sent to authorized individuals within the information technology infrastructure.

12. The method of claim 1, wherein implementing the plurality of attack-prevention procedures comprises the step of:
implementing a multi level security system comprising a plurality of users having access only to information designated for each individual user.

13. The method of claim 1, wherein implementing the plurality of attack-prevention procedures comprises the step of:
providing mechanisms to prevent a delivery of a malicious software, detect an existence of the malicious software, and provide a remedy to remove the malicious software.

14. The method of claim 1, wherein implementing the plurality of attack-prevention procedures comprises the step of:
providing a plurality of secure identifiers for each of a plurality of users, devices, and services within the information technology infrastructure.

15. The method of claim 1, wherein employing the plurality of cyber defense procedures further comprises the step of:
assimilating information from a plurality of mechanisms within the information technology infrastructure to detect the malware software.

16. The method of claim 1, wherein employing the plurality of cyber defense procedures further comprises the step of:
detecting hidden data flows comprising the detection of information hidden within a stream of information that is transmitted from one entity to another.

17. The method of claim 1, wherein employing the plurality of cyber defense procedures further comprises the step of:
identifying unauthorized entities within the information technology infrastructure.

18. The method of claim 1, wherein employing the plurality of cyber defense procedures further comprises the step of:
comparing assimilated information from a plurality of mechanisms within the information technology infrastructure to a plurality of predetermined baselines so as to detect malicious modifications and corruption of files within the information technology infrastructure.

19. The method of claim 1, wherein employing the plurality of cyber defense procedures further comprises the step of:
providing graphical, statistical, and analytical visualization of the threatened information within the information technology infrastructure.

20. The method of claim 1, wherein employing the plurality of cyber defense procedures further comprises the step of:
providing trends of past security attacks comprising manual and automated tools to detect and characterize unrecognized patterns within data.

21. The method of claim 1, wherein implementing the plurality of response and recovery procedures further comprises the steps of:
determining a portion of the information technology infrastructure that has been attacked;
determining a level of damage of the attack; and
determining an origination of the attack.

22. The method of claim 1, wherein implementing the plurality of response and recovery procedures further comprises the step of:
utilizing incident response history data that provides guidance on handling an attack.

23. The method of claim 1, wherein implementing the plurality of response and recovery procedures further comprises the step of:
implementing temporary changes to the information technology infrastructure in response to the attack.

24. The method of claim 1, wherein implementing the plurality of response and recovery procedures further comprises the step of:
implementing deception tactics to guide attackers away from production systems and into a plurality of contained and monitored environments.

25. The method of claim 1, wherein implementing the plurality of response and recovery procedures further comprises the step of:
reverse engineering the malicious software code so as to counteract an attack based on the reversed engineered code.

26. A method of providing a cyber security offense comprising:
implementing a plurality of cyber weapon procedures configured to attack a plurality of targeted networks and information systems;
implementing a plurality of cyber intelligence surveillance and reconnaissance procedures configured to assess the weaknesses of the plurality of targeted networks and information systems;
implementing a plurality of information operation target exploitation procedures configured to collect, destroy and disrupt data contained within the plurality of targeted networks and information systems; and
implementing a plurality of information operation attack procedures configured to circumvent and access security controls of the plurality of targeted networks and information systems, wherein the access is used to destroy resources and data controls of the plurality of targeted networks and information systems.

27. The method of claim 26, wherein the implementing the plurality of cyber weapon procedures comprises the step of:
utilizing a plurality of malicious software and hardware devices to deny, disrupt and destroy the plurality of targeted networks and information systems.

28. The method of claim 27, wherein the implementing the plurality of cyber weapon procedures comprises the step of:
utilizing reverse engineering to conceal the plurality of malicious software and hardware devices.

29. The method of claim 26, wherein the implementing the plurality of cyber intelligence surveillance and reconnaissance procedures comprises the step of:
probing and monitoring the plurality of targeted networks and information systems so as to access a plurality of internal and external attack surfaces of the plurality of targeted networks and information systems.

30. The method of claim 26, wherein the implementing the plurality of cyber intelligence surveillance and reconnaissance procedures comprises the step of:
deceiving the plurality of targeted networks and information systems so as to misdirect the resources and capabilities of the plurality of targeted networks and information systems.

31. The method of claim 26, wherein the implementing the plurality of information operation target exploitation procedures comprises the step of:
capturing data of interest by exploring directories, file shares and repositories within the of the plurality of targeted networks and information systems.

32. The method of claim 26, wherein the implementing the plurality of information operation target exploitation procedures comprises the step of:
establishing control of resources within the plurality of targeted networks and information systems.

33. The method of claim 26, wherein the implementing the plurality of information operation target exploitation procedures comprises the step of:
concealing and exporting captured data from the plurality of targeted networks and information systems.

34. The method of claim 26, wherein the implementing the plurality of information operation attack procedures comprises the step of:
circumventing the security controls of the plurality of targeted networks and information systems so as to destroy data within and mount a denial of service to the plurality of targeted networks and information systems.

35. The method of claim 26, wherein the implementing the plurality of information operation attack procedures comprises the step of:
utilizing an authorized user to circumventing the security controls of the plurality of targeted networks and information systems.

36. The method of claim 26, wherein the implementing the plurality of information operation attack procedures comprises the step of:
inserting of the plurality of malicious software and hardware devices into the supply chain of the of targeted networks and information systems.

37. A method of providing a cyber security defense and offense comprising:
assessing a plurality of security risks in an information technology infrastructure;
implementing a plurality of attack-prevention procedures configured to control access to the information technology infrastructure;
providing a plurality of security policies for the information technology infrastructure;
employing a plurality of cyber defense procedures configured to detect at least one violation of the plurality of security policies;
implementing a plurality of response and recovery procedures configured to automatically respond to the at least one violation of the plurality of security policies;
implementing a plurality of cyber weapon procedures configured to attack a plurality of targeted networks and information systems;
implementing a plurality of cyber intelligence surveillance and reconnaissance procedures configured to assess the weaknesses of the plurality of targeted networks and information systems;
implementing a plurality of information operation target exploitation procedures configured to collect, destroy and disrupt data contained within the plurality of targeted networks and information systems; and
implementing a plurality of information operation attack procedures configured to circumvent the security controls of the plurality of targeted networks and information systems, wherein the access is used to destroy resources and data controls of the plurality of targeted networks and information systems.
